(19) United States
(12) Patent Application Publication
(10) Pub. No.: US 2008/0277127 A1
(43) Pub. Date: Nov. 13, 2008

(54) Quick change rotary mower blade

(76) Inventor: Carl Dixon, Weiner, AR (US)

Correspondence Address: DENNIS B. HAASE, P.O. BOX 6206, HOT SPRINGS, AR, 71902-6206, US

(21) Appl. No.: 11/801,889

(22) Filed: May 11, 2007

(51) Int. Cl. A01D 34/63

(52) U.S. Cl. 172/552

(57) ABSTRACT

An improved rotary mower blade in which a carrier which is rotatably connect to a spindle driven by the mower engine, receive and holds a pair of opposed sharpened cutting segments. The cutting segments are held in place while the carrier is rotated, and are removable and replaced as needed when the carrier is stationary.

The present invention relates, in a general sense, to improvements in blades for rotary mowers and, in particular, to a blade in which the sharpened sections are quickly and conveniently changeable to install sharpened sections as needed, and without special tools.

### BACKGROUND OF THE INVENTION

1. Field of the Invention

Rotary mowers, irrespective of size or intended purpose, have a blade which rotates about a central point, typically a spindle, and within a protective housing. The end sections of the blade are sharpened and are designed to cut, and sometimes mulch, the material which comes within the housing as the mower is moved over a grassy surface, e.g, a lawn.

Even the most pristine of lawns has some twigs and rocks, and mowers will eventually pass over them, in consequence of which the sharpened edges of the blade segments become damaged and/or dulled. In addition to the special circumstances enumerated above, normal wear and tear will dull blades in the normal course of usage. It is easy to visualize the savings in time and effort to be achieved if it were possible to change the sharpened sections of a blade without having to carry a wrench and extra blades, some of which reach to 36″ or more in diameter, and get underneath the mower to detach and mount a new blade every time one is needed.

2. Overview of the Prior Art

The inevitable consequences of dull rotary blades is not a recent revelation. However, those who have ventured a solution have attacked the problem from the standpoint of quickly detaching and attaching the entire blade to the spindle. Typical of such efforts is Bontrager et al. U.S. Pat. No. 6,205,755. Bontrager teaches an adapter, the parts of which detach from one another to release the blade which is fixed to one of them. Extra parts and whole blades must be carried with the user. There is a better way.

### SUMMARY OF THE INVENTION

It should be increasingly evident that the present invention addresses the question of how best to maintain the efficiency of rotary mowers, and it is an objective to accomplish maintenance of efficiency by providing a method for quickly changing the sharpened sections of a rotary blade and thereby minimize down time.

It is a companion objective to provide a low cost alternative to the requirement for additional couplers and adapters to effect a competent change of a rotary mower blade.

Yet another objective of the present invention is to accomplish the foregoing objectives safely and with such simplicity that a change can be readily effected in the field by an operator, without carrying his or her tool chest while working.

The foregoing, as well as other objectives and advantages of the present invention will become more apparent from a reading of the following Detailed Description of a Preferred Embodiment, taken in conjunction with the drawing, wherein:

### DESCRIPTION OF THE DRAWINGS

FIG. 1 is a pictorial representation of a typical rotary mower as viewed from beneath the mower and illustrating the quick change system of the present invention;

FIG. 2 is a pictorial representation of a quick change blade constructed in accordance with the present invention;

FIG. 3 is a view similar to FIG. 2, but illustrating how the sharpened segments of the blade mount and dismount to the carrier;

FIG. 4 is a partial section of the blade of FIG. 2, emphasizing the interconnection of the sharpened segment with the carrier;

FIG. 5 is a view similar to that of FIG. 4, showing the interconnect parts separated;

FIG. 6 is a top plan view of the blade of FIG. 2;

FIG. 7 is a side elevation of the blade of FIG. 2;

FIG. 8 is an end view of the carrier portion of the blade of FIG. 2, showing the engagement flanges thereof;

FIG. 9 is a bottom plan view of the structure of FIG. 8;

FIG. 10 is a partial sectional view taken along lines 10-10 of FIG. 9;

FIG. 11 is a view similar to FIG. 10, showing an additional structure;

FIG. 12 is a view similar to that of FIG. 6, but illustrating a slight modification in which a protective sleeve is used as an additional safety feature;

FIG. 13 is a pictorial representation of the use of the sleeve of FIG. 12; and,

FIG. 14 is a perspective view of an example of a extension used in FIG. 12 showing a sharpened edge on both sides thereof.

### DETAILED DESCRIPTION OF A PREFERRED EMBODIMENT

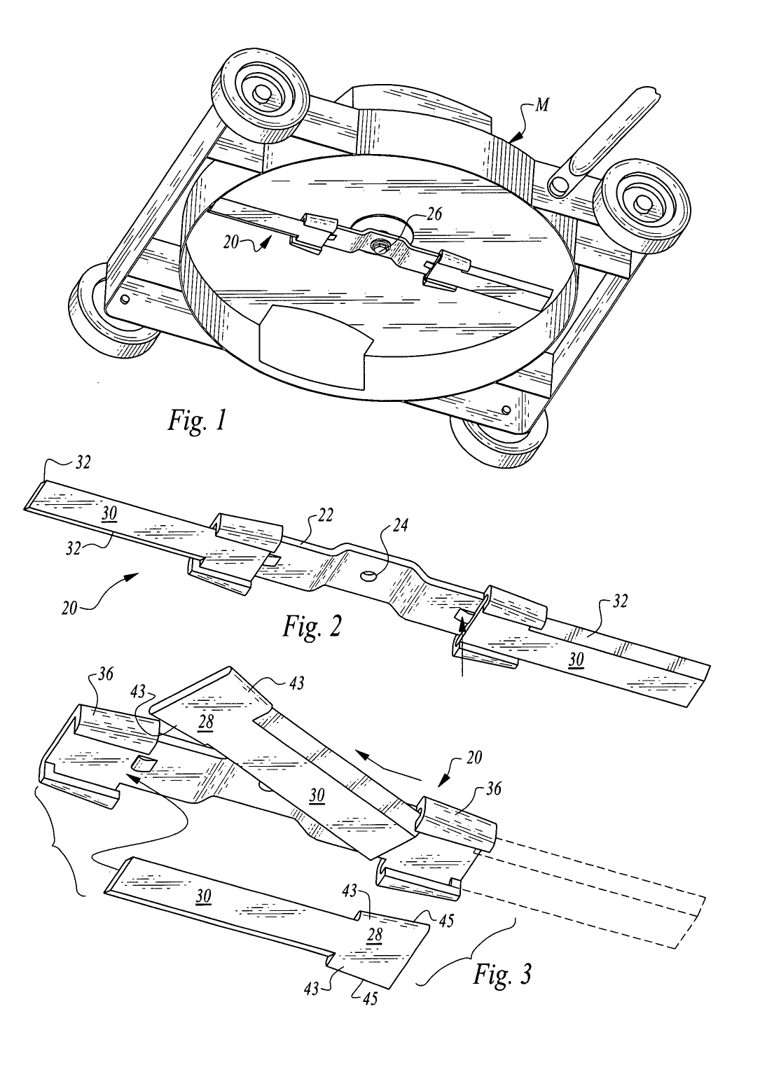

With reference now to the drawings, and initially to FIG. 1, a quick change blade 20 is shown in a typical environment in which such blades have primary, although not exclusive, utility.

The blade 20 is shown mounted in the well of a mower housing H of a residential lawn mower. The same blade works very well in a variety of commercial rotary mowers.

It is a primary purpose of the quick blade of the present invention to provide operators with a means of refreshing their mower blades quickly, safely and in the field where necessary, thereby cutting down time and increasing efficiency at minimal cost.

In accomplishing these objectives, the quick change blade 20 includes a carrier 22. The carrier 22 is provided with a central aperture 24 which receives a spindle 26. The spindle 26 is driven by the motor, either directly or indirectly, through a belt system, depending on the mower unit M involved. The carrier 22 supports a pair of sharpened extensions or segments 30 at the respective ends thereof. Each segment has a sharp edge 32 which defines the cutting area of the blade.

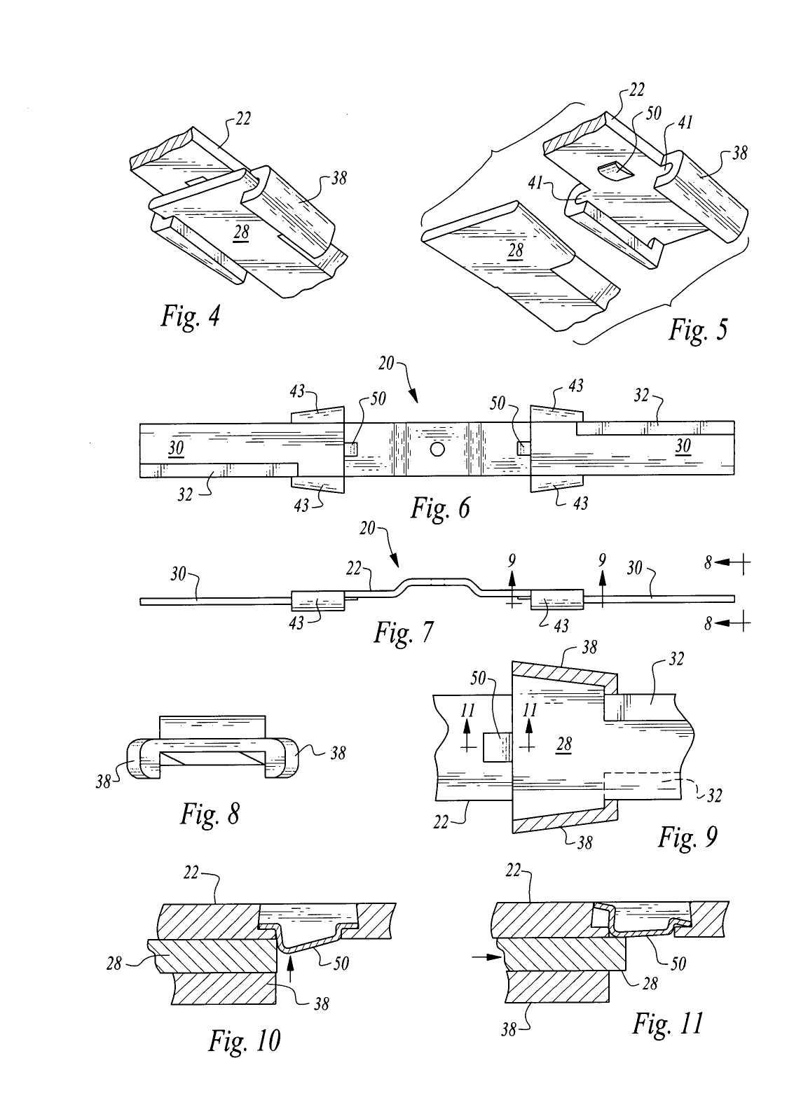

The extensions or segments 30 are removably seated at the remote ends of the carrier 22 where they are held in place along the longitudinal axis of the carrier by means of connectors at the remote ends. Referring to FIGS. 3 through 5, a connector 34 is illustrated at the remote ends or termini 36 of the carrier 30. The illustrated connector comprises a pair of peripheral rails or flanges 38 which give a general appearance of a claw. Each flange is provided with a longitudinal groove or slot 41. The slots 41 of each given connector are in a single plane which plane lies parallel with the plane of carrier and converge toward the central axis of the carrier and are constructed to hold an extension in axial alignment with the carrier.

In order to be received in the connector 34, the free, unsharpened end 28 of the extension 30 is formed with outwardly extending wings 43, perhaps best seen in FIG. 3. The outer edges 45 are tapered inwardly toward the longitudinal axis of the extension, and the wings are of such dimension that they slide into the slots 41.

It will now become evident that as the carrier is rotated, centrifugal forces will act on the extension 30 positioned at the ends thereof, to hold it securely wedged in the grip of the flanges. Therefore, as long as the blade is rotating, the sharpened segments, or extensions, will remain securely in cutting position and cut as though the blade were a single one piece unit.

Once the blade stops rotating, the segments 30 are readily removed from the carrier and replaced with sharpened segments, or in the case of the segment of FIG. 14, turned over to face the other sharpened edge in play, all in a matter of several seconds, and the mower is ready to resume its task.

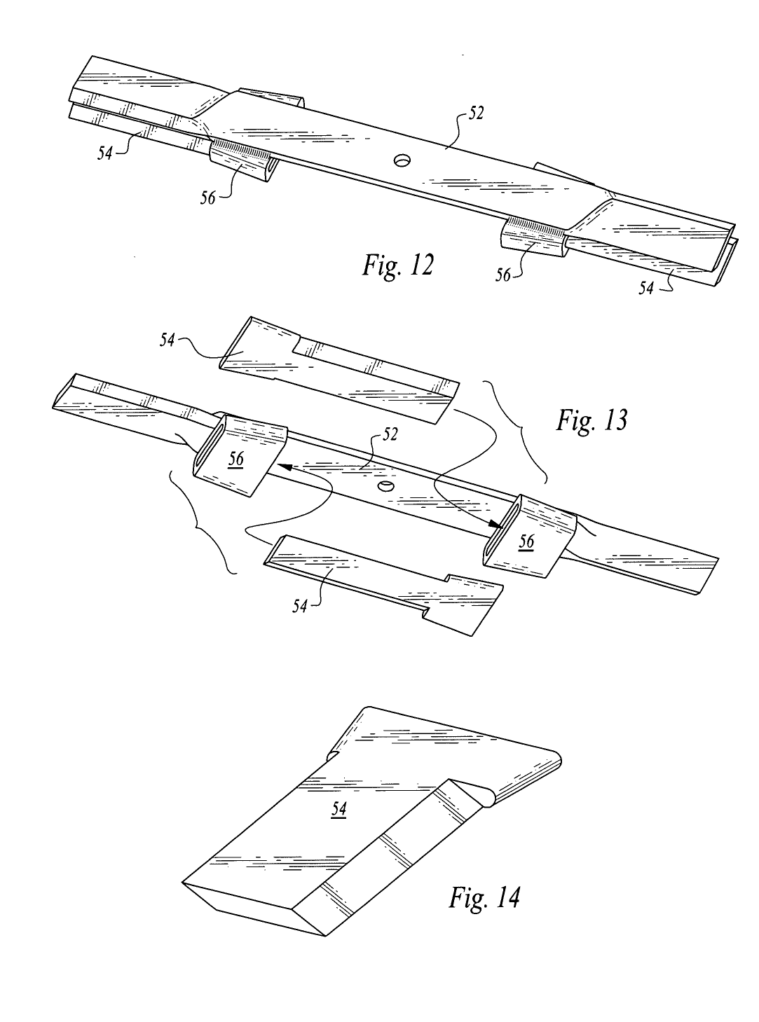

A slightly modified form of the carrier is depicted in FIGS. 12 through 14. Referring to FIG. 12 a modified blade 50 is shown and includes a carrier 52, which supports sharpened segments, or extensions, 54. Affixed to the respective ends of the carrier 52, such as, e.g., welding, are sleeves 56. The sleeves 56 are tapered toward the longitudinal axis of the extension, and have an internal slot, dimensioned to receive and hold the free end 28. As in the case of the FIG. 2 embodiment, centrifugal force will secure the extensions during rotation of the carrier. The sleeve, however, provides an element of additional security while the mower is in storage or being transported from location to location.

The present invention anticipates that the surface being mowed is often less than uniform or free from rocks, twigs, roots and other impediments which inevitably come in contact with the blade of the mower. When a rapidly rotating blade comes into contact with one of these impediments, it not only nicks the sharpened blade edge, it gives the blade a jolt. When, as in the present case, the blade is formed on an extension, there is some chance that the extension could become dislodged from its secure position in the grip of the carrier. In order to minimize such an occurrence, a detent 50 is provided, which is biased outwardly from the carrier by a spring or other suitable well known means. The detent is positioned on the carrier so as to abut the extension when it is in its operative position, as seen in FIG. 2, for example, thereby inhibiting its movement from that position until the detent 50 is manually depressed.

Having now described a preferred embodiment and some variations thereon in some considerable detail, some other variations, as yet not described, will occur to those skilled in the art. It will be understood that those variation, while not specifically mentioned, are nonetheless within the contemplation of the invention as defined by the accompanying claims, wherein:

1. A quick change rotary mower blade comprising a carrier, said carrier connected to the spindle of a rotary mower such that rotation of the spindle rotates said carrier;
a pair of extensions, said extensions having at least one sharpened edge; said extensions being removable affixed to said carrier, and rotatable therewith to cut grasses growing beneath said rotary mower blade.

2. The quick change rotary mower blade of claim 1, wherein each said extension has opposed sharpened edges.

3. The quick change rotary mower blade of claim 1, having a pair of connectors, said connectors being disposed at each end of said carrier, said connectors each adapted to engage an extension to hold each said extension in cutting position during rotation of said carrier.

4. The quick change rotary mower blade of claim 3, wherein each connector has an unsharpened and a sharpened end, said sharpened end having a pair of wings, said wings tapering towards the longitudinal axis of said extension;
said unsharpened end adapted to be received in said connector such that rotation of said carrier holds said extension wedged in said connector.

5. The quick change rotary mower blade of claim 3, wherein said connector comprises a pair of opposed flanges on either side of said carrier, said flanges being formed with a slot therein, said slot being tapered towards the longitudinal axis of said carrier and parallel thereto, said slots being adapted to receive said extensions to hold said extensions to said carrier during rotation.

6. The quick change rotary mower blade of claim 1, wherein said extensions are affixed in axial alignment with said carrier.

7. The quick change rotary mower blade of claim 5, wherein said slots lie in a single plane parallel to the plane of said carrier.

8. A quick change rotary mower blade comprising a carrier, said carrier connected to the spindle of a rotary mower such that rotation of the spindle rotates said carrier;
a pair of extensions, said extensions having at least one sharpened edge; said extensions being removably affixed to said carrier, and rotatable therewith to cut grasses growing beneath said rotary mower blade;
a pair of connectors, said connectors being disposed at each end of said carrier, said connectors each adapted to engage an extension to hold each said extension in cutting position during rotation of said carrier, and said connectors are in the nature of sleeves.

9. The quick change rotary mower blade of claim 8, wherein said connectors hold said extensions in axial alignment with said carrier.

10. The quick change rotary mower blade of claim 8, wherein said sleeves being formed with opposed grooves; said grooves adapted to receive and hold said extensions as said carrier is rotated.

11. The quick change rotary mower blade of claim 8, wherein said connectors are adapted to receive said extensions in sliding engagement with said carrier during rotation of said carrier, and being replaceable when said carrier is stationary.

12. The quick change rotary mower blade of claim 8, wherein each said extension has opposed sharpened edges.
